(19) United States
(12) Patent Application Publication
(10) Pub. No.: US 2007/0151135 A1
(43) Pub. Date: Jul. 5, 2007

(54) Bike anti-theft numbering/marking system

(76) Inventor: Ruey-Shong Nelson Lin, Gilbert, AZ (US)

Correspondence Address: RABIN & Berdo, PC, 1101 14TH STREET, NW, SUITE 500, WASHINGTON, DC, 20005, US

(21) Appl. No.: 11/319,525

(22) Filed: Dec. 29, 2005

(51) Int. Cl. G09F 21/04

(52) U.S. Cl. 40/591

(57) ABSTRACT

A bicycle (or other vehicle), that has a serial number, has a marking (preferably the last number or few numbers of the serial number) imprinted on the frame in such a way that at least one of the numerals is readable from a distance of at least 2 feet (characters at least one quarter of an inch high). This allows the bicycle owner to quickly identify his or her bike among many others that are similar in appearance, when it is parked in a large group, or it has been stolen. If several numbers of the serial number are imprinted on the bike, then one of them can be written larger, and the others smaller. The marking can also be a combination of colors and/or picture and/or a specially designed graphic. If the bike is suspected of being stolen, the marking as well as the full serial number can read off the bike frame and then be accessed in a database via the Internet, which will identify the actual owner.

### FIELD OF THE INVENTION

The present invention is directed to a marking system for bicycles and scooters, and other transportation devices to deter theft and aid in identification of a marked device, for example, picking out the marked bicycle among hundreds of other parked bicycles.

### BACKGROUND OF THE INVENTION

A bicycle can be stolen relatively easy, especially around a college or university campus. Due to its lightness, a thief can put it into a car even if it has a lock on its wheel. Although a bike can be locked onto a fixed structure, no lock is unbreakable. Most bike locks can be broken with or without a tool within one minute. Losing a bike to a thief is a common experience of bike owners.

After a bike has been stolen, the owner normally tries to locate the stolen bike. However, most bikes look similar to all the others and that makes it difficult to identify a stolen bike. Usually the bike frame has a serial number stamped on it for identification purposes. However these numbers are small (normally only approximately 3/16 inch by ⅛ inch) and almost invisible especially when covered by paint. One cannot identify the bike by these number from a distance (i.e., from more than a few inches away). Also, the serial number normally is stamped in a location where it cannot be seen without turning the bike upside down. This makes identifying one bike among lots of other bikes (such as bikes in front of a library, a train station, or a student dormitory) very time consuming if not impossible.

This invention has an object to provide a marking system to enable an owner to easily tell whether a bike or other vehicle is possibly his or hers, and then make a decision as to whether or not a more careful observation or examination is required. The efficiency of identifying his/her own bike is several times easier by this method.

### SUMMARY OF THE INVENTION

This invention includes putting at least one large, uniquely identifiable mark, possibly a big alphabet letter or numeral which is preferably the same as the last digit or letter of the bike serial number, on the bike frame such that it can be seen from at least 2 feet away. That is, a person having normal vision should be able to see the marking with un-assisted eyes (i.e., without binoculars or a telescope) from the distance of 2 feet. Another distance, such as 10 feet, may also be chosen.

This mark, which can be a numeral, letter, color sequence, graphic character, or other marking, is not for decoration or a cosmetic purpose but for identification. The marking allows one to easily identify if a bike is possibly his or hers from a distance, among a row of bikes or while someone is riding it.

If the large number (numeral) on a bike is the same as the some digit of the identification number of the owner's stolen bike, then the owner can than walk closer and read the actual serial number. Even if every bike has one number, the efficiency of identifying a lost bike is increased at least ten times (there are ten digits 1, 2, 3, . . . 8, 9, 0, so nine of ten marked bikes can be eliminated at once). If not every bike is marked, the efficiency is still greater.

If more than one numeral is used, for example the last two or three digits of the identification number, then the bike can be identified as one in a hundred or one in a thousand, respectively.

### BRIEF DESCRIPTION OF THE DRAWING FIGURES

FIG. 1 is an elevational, partially schematic view of the invention.

### DETAILED DESCRIPTION OF THE PREFERRED EMBODIMENTS

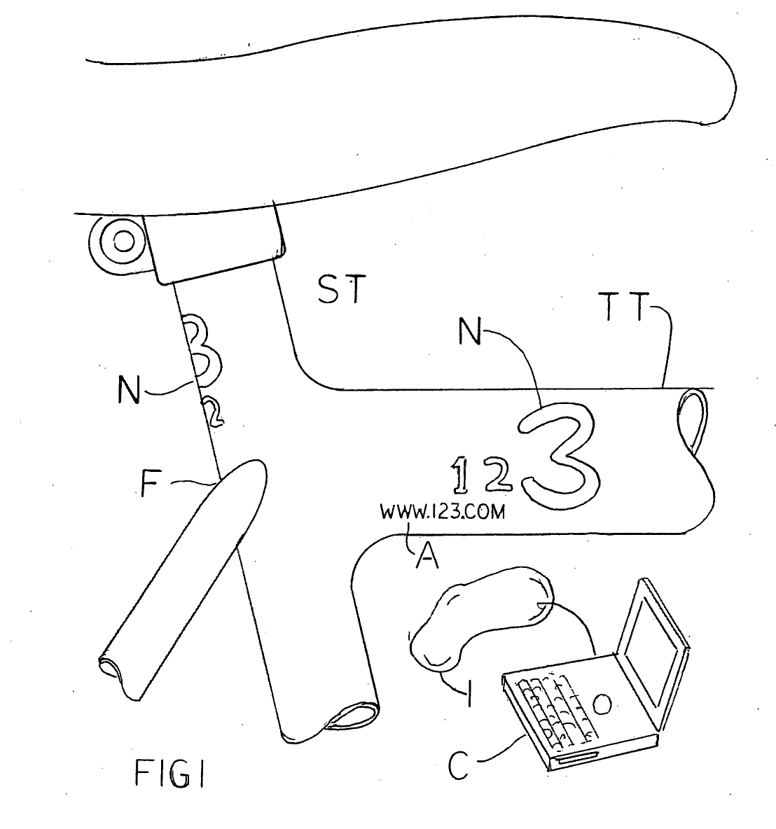

FIG. 1, including a partial view of a bicycle frame F, shows two possible locations of a numeral N (number) or other marking on a bike frame, namely, on the top tube TT where the numeral N can be seen from the side, and the seat tube ST, where the number can be read from behind. It can also be on the bicycle's down tube (not illustrated) so that it can be seen from the side when someone is riding the bike. (A marking on the top tube TT may be obscured by a rider's legs). One, two, or all three locations can be used, and any other location can also be used.

The figure illustrates markings for a bicycle with an identification number ending in “123” (which is of course only an example). Alternatively, the numerals N could be taken from some other portion of the identification number, or be taken non-sequentially, or combined with other markings that do not refer directly to the identification number, or that do not include it in any way.

In the marking N on the top tube TT, the three numerals N are generally in a line and the third is bigger than the other two; the other two may be of similar size but need not be. Numerals other than the last in sequence could also be made larger (not shown). In the marking N on the seat tube ST, the third numeral N is generally above the other two (the “1” is not visible because of the curvature of the seat tube) and the third numeral N is bigger than the other two. Any number of numerals N can be used and they can be deployed in any arrangement.

The size of marking N could be approximately a half inch or larger. The color should be such that the marking N can easily be seen from a distance. Reflective paint can be used for easier identification.

One main purpose of this marking N is to make a thief worry that the bike can be easily identified. This worry will deter a thief from trying to steal it in the first place. Also, if the thief does steal it, he or she will get rid of it as soon as possible, before someone catches him or her using it.

Preferably, the anti-theft number can be associated with an Internet-based database 1, shown schematically in FIG. 1, that lists the bike's serial number and its owner's information. A section of this web site will allow the owner to post a notice that his/her bike is lost, and/or a notice that a lost bike is found, and/or a method for the owner, a finder, or the police to contact each other, all via a computer C or some other Internet-access device.

If police, or other people, should find a dumped bike, they will instantly see the anti-theft number and therefore know that this bike has web site support. (The web address A can be printed on the bike.) They can get on the Internet web site I and see if this bike has been stolen and how the owner can be reached, by using its serial number.

The marking N can easily be placed on the bicycle frame F during manufacturing before applying the last transparent coating on the frame F. In this way, it cannot be removed or altered without damaging the bike paint. Other methods or structures can also be used to ensure that it cannot be removed or altered without visibly damaging the bike's surface.

Of course, the thief can scratch and destroy the marking N. However, the destroyed marking itself says that the bike is not coming from a regular channel and possibly is a stolen one. Destruction of the marking reduces the bike's resale value and encourages others to check its stamped serial number. As the anti-theft numbering system becomes more popular, it is possible that people will feel ashamed to ride a bike with a destroyed marking.

The number on the marking N can be more than one digit. One example is the last 3 digits of the bike serial number. In this case, the numerals can be a mixture of different sizes. For example, one large last digit can be printed with two smaller preceding digits under it. In this way, owner identification process is even easier.

Other than the bike identification number, the marking N can be a series of characters such as A, B, C, . . . , α, β, x . . . or any common sequence or system or combination that is known by the general public. The marking N can be a combination of both alphabet and characters. In such a combination the letters and characters do not need to be the same size.

Other than the number and/or character, the marking N can be a series of color graphics, for example red, orange, yellow, green, and blue, like the colors in a rainbow.

Other than the number and/or character and/or color graphics, the marking N can be a picture or graphic specifically created/designed/assigned, such as the owner's picture and/or signature.

This bike anti-theft marking system is also good for identifying one's own bike among hundreds of parked bicycles, such as those near to a subway station or a ballpark, as well as for deterring theft and recovering a stolen bike.

Besides bicycles, it is contemplated that scooters, motorcycles, skateboards, and other vehicles, whether motorized or not, can use this system. In the following claims, these are referred to collectively as personal moving devices.

1. In combination:
a personal moving device; and
a marking uniquely identifying the personal moving device, comprising a numeral, graphic design, or color sequence, imprinted on the personal moving device, wherein the marking is readable from a distance of at least 2 feet with un-assisted eyes.

2. The combination according to claim 1, wherein the personal moving device further has a serial number permanently printed thereon, and wherein the marking is a digit of the serial number.

3. The combination according to claim 2, wherein the marking is the last digit of the serial number.

4. The combination according to claim 3, wherein the marking includes a plurality of digits of the serial number.

5. The combination according to claim 4, wherein one digit of the marking is printed larger than other digits of the marking.

6. The combination according to claim 2, wherein the marking includes the last 3 digits of the serial number.

7. The combination according to claim 6, wherein one digit of the marking is printed larger than the other two digits of the marking.

8. The combination according to claim 7, wherein the larger digit of the marking is printed above the other digits of the marking.

9. The combination according to claim 8, wherein the personal moving device is a bicycle and the marking is imprinted on at least one of the side of a top tube, the side of a down tube, or the back of a seat tube of the bicycle.

10. The combination according to claim 1, wherein the marking is the color sequence which comprises a series of color graphics that contrast to a surrounding area of the personal moving device.

11. The combination according to claim 1, wherein the marking cannot be removed without causing visible damage to a surface of the personal moving device.

12. The combination according to claim 1, wherein the marking is at least ¼ inch high.

13. The combination according to claim 2, further comprising
an Internet-based database that lists the serial number and contains information on an owner of the personal moving device.

14. The combination according to claim 1, further comprising
an Internet-based database that contains information on the marking and associates the marking with an owner of the personal moving device.

15. A method comprising:
providing a personal moving device having a serial number permanently associated therewith:
imprinting on the personal moving device a further marking comprising at least one digit of the serial number, wherein the marking is at least ¼ inch high; and
providing an Internet-based database that lists the serial number and contains information on an owner of the personal moving device.

16. The method according to claim 15, wherein the marking comprises a plurality of the digits of the serial number.

17. The method according to claim 15, wherein the digit is the last digit of the serial number.

18. At least one marking, not related to a trade mark or model name, imprinted on a personal moving device frame, that is visible and can be seen from at least two feet away with un-assisted eyes.

19. The character or graphic mark according to claim 18, wherein the marking is a plurality of characters, graphic marks, a picture or a signature.

20. The character or graphic mark according to claim 18, wherein the marking cannot be removed without causing visible damage to a surface of the personal moving device frame.
